(19) United States
(12) Patent Application Publication
(10) Pub. No.: US 2026/0264388 A1
(43) Pub. Date: Sep. 10, 2026

(54) DECORATIVE PANEL AND METHOD FOR MANUFACTURING A DECORATIVE PANEL

(71) Applicant: UNILIN, BV, Wielsbeke (BE)

(72) Inventor: Benjamin CLEMENT, Wielsbeke (BE)

(21) Appl. No.: 18/881,577

(22) PCT Filed: Jul. 5, 2023
(86) PCT No.: PCT/IB2023/056966

§ 371 Date: Jan. 6, 2025

Related U.S. Application Data
(60) Provisional application No. 63/358,981, filed on Jul. 7, 2022.

(51) Int. Cl. B32B 38/06; B32B 3/30; B32B 27/08; E04F 15/10

(52) U.S. Cl. CPC B32B 38/06; B32B 3/30; B32B 27/08; E04F 15/107; B32B 2307/584; B32B 2307/7376; B32B 2419/04

(57) ABSTRACT

A method for manufacturing a decorative panel, includes the steps of: providing a substrate material, and providing at least a decorative layer and a wear layer onto the substrate material. The wear layer is located above the decorative layer, providing a curable lacquer on the wear layer, and embossing at least the curable lacquer. The thickness of the wear layer and the thickness of the curable lacquer follow a ratio of between 5:1 and 1:25.

The present invention relates to a decorative panel and a method for manufacturing a decorative panel.

In particular, the invention relates to decorative panels, for which laminate floor panels, parquet floor panels, and floor panels based on synthetic material are known examples. More in particular, in the class of floor panels which are based on synthetic material, LVT, WPC, and SPC floor panels are known examples. These floor panels mostly have a thermoplastic substrate, which, apart from the thermoplastic synthetic material, may also comprise additives and/or fillers. The top layer of these floor panels mostly also is composed of one or more thermoplastic layers. Reference is made to document WO 2013/026559 for an exemplary composition of such product.

Similarly to laminate floor panels, it is the intention that these synthetic material-based floor panels comprise an upper surface reflecting a natural character. To this aim, use is generally made of a decor and an embossed wear layer, by which a relief is realized in the upper surface of the floor panel. Again, reference is made to document WO 2013/026559, in which such example is described. However, with synthetic material-based floor panels, obtaining a natural look and feel may be problematic. This is especially so because of the type of wear layer that is mostly applied, namely a thermoplastic wear layer. Not only is this wear layer mostly scoring unsatisfactorily in respect to features such as wear resistance, scratch resistance, stain resistance and the like. Moreover, it also gives a plastic-like appearance to the floor panels, which is caused by the highly glossy character thereof. In order to address these problems, it is known to provide a lacquer layer above or on the wear layer. However, the known techniques thereof have proven insufficient, certainly in the case that the upper surface of the floor panel has a relief.

In the document WO 2013/026559, it is described to apply a lacquer layer on an embossed or deformed wear layer. However, the inventor has found that with this technique there is a high risk that glossy spots are visible in the upper surface of the floor panel. These spots are annoying and give an unnatural appearance to the floor panel. The problem seems to rise in particular with deep relief.

Document EP 2 883 712 describes providing two lacquer layers on a wear layer, with the aim of creating a difference in gloss degree. Although thereby the artificial look of the wear layer can be addressed, purely applying two lacquer layers seems not sufficient for removing the risk of glossy spots.

In document U.S. Pat. No. 6,746,756 is described to provide a lacquer layer on a wear layer and then embossing the lacquer layer in order to form a relief. Contrary to the above-mentioned document WO 2013/026559, the lacquer layer as such is embossed. There however remains a risk that the superficial lacquer layer of U.S. Pat. No. 6,746,756 may get interrupted, thereby making the underlaying wear layer visible. This would again lead to visibility of unwanted glossy spots. Furthermore, with the superficial lacquer layer of U.S. Pat. No. 6,746,756 it is still difficult to obtain a decorative panel with a good score in respect to features such as wear resistance, scratch resistance, stain resistance and the like. Furthermore, by combining a wear layer and a lacquer layer as described in any of the aforementioned documents, the underlaying decorative layer may not be optimally visible. In particular, due to the combined wear layer and lacquer layer, the visual appearance of the decorative layer may be somewhat faded, or a certain haze may be visible, such that the decorative panel does not have a natural appearance.

There thus remains a need in the art to further improve the visual appearance of decorative panels, in particular to provide them with a more natural visual appearance. In particular, there remains a need to further improve visual appearance while still providing said decorative panels with sufficient, or even improved, scratch and/or wear resistance.

The present invention in the first place aims to provide a decorative panel, wherein in accordance with preferred embodiments one or more problems of the state-of-the art may be solved.

A first independent aspect of the present invention provides a method for manufacturing a decorative panel, comprising the steps of:
providing a substrate material,
providing at least a decorative layer and a wear layer onto said substrate material, wherein said wear layer is located above said decorative layer,
providing a curable lacquer on said wear layer, and
embossing at least said curable lacquer,
   wherein the thickness of said wear layer and the thickness of said curable lacquer follow a ratio of between 5:1 and 1:25.

Preferably, said wear layer is a prefabricated thermoplastic foil, e.g. a foil of Polyvinyl chloride (PVC). The PVC of the wear layer may be plasticized or not. Preferably the wear layer is free of plasticizer or comprises an amount of plasticizer of 5 phr or less. In such case a very firm final wear protection is obtained over the decorative layer. According to an alternative the PVC of the wear layer comprises at least 15 phr of plasticizer, or, at least 25 phr of plasticizer or more. In such case a sound attenuating effect may be obtained rather close to the surface of the decorative panel. This is of special importance in case the decorative panel is a floor panel. It is of course not excluded that plasticizer levels between 5 and 15 phr are practiced, in which case an optimum balance between final wear resistance and sound attenuation may be obtained.

According to an alternative, said wear layer is liquidly applied and is e.g. a UV curable or UV cured hotmelt. Such embodiment is of special interest when said decorative layer is obtained by applying inks directly on said substrate material, potentially with the intermediate of one or more primer layers.

Preferably said wear layer has a thickness of at least 50 micrometer, or at least 100 micrometer or more. A good value for the thickness of the wear layer is about 100 micrometer. As mentioned in the first aspect, the curable lacquer has a thickness of at least one fifth of said thickness. In the case of a wear layer of about 100 micrometer, a curable lacquer of 100 or more, or even of 150 micrometer or more may be applied on said wear layer.

It is clear that said wear layer is preferably transparent or translucent. The same is true for said curable lacquer when in finally cured condition.

The invention may have one or more advantages over what is known in that by following the above-mentioned ratio, a thinner wear layer may be applied. Using a thinner wear layer may have the advantage that transparency is improved, thus making the decorative layer underneath better visible at the surface of the decorative panel. Furthermore, by combining a wear layer and a curable lacquer following the above-mentioned ratio, at least the same scratch and/or wear resistance, or an even improved scratch and/or wear resistance, may be obtained in comparison to wear layers which are known in the art. By embossing at least the substantially thick curable lacquer, the risk may furthermore be reduced of having uncoated spots on the surface of the decorative panel, and gloss of the surface of the decorative panel may be determined by the curable lacquer layer and/or by the embossment structure. As such, the present invention allows for providing a decorative panel with improved visual appearance and/or with improved scratch and/or wear resistance.

By preference, the thickness of said wear layer and the thickness of said curable lacquer follow a ratio of between 4:1 and 1:20, more by preference of between 3:1 and 1:15, even more by preference of between 2:1 and 1:10, most by preference of between 1:1 and 1:10. With increased preferability, the transparency is further improved while still maintaining at least the same scratch and/or wear resistance, or while even improving the scratch and/or wear resistance.

For providing said curable lacquer on said wear layer several possibilities are envisaged, of which here below two are described without desiring to be exhaustive.

According to a first possibility, said curable lacquer is provided partially, at least partially, or wholly onto said wear layer before the step of providing at least said decorative layer and said wear layer onto said substrate material. This may allow a more easy application of the curable lacquer on the wear layer and/or may allow that the thickness ratio of the curable lacquer with regard to the wear layer can be set more accurately. By applying the curable lacquer before the step of providing at least the decorative layer and the wear layer onto the substrate material, the combined curable lacquer and wear layer may be prepared offline and/or may be prepared in advance, which may simplify the manufacturing process and/or improve its efficiency.

According to a second possibility, said curable lacquer is provided onto said wear layer between the step of providing at least said decorative layer and said wear layer onto said substrate material, and the step of embossing said curable lacquer. By providing the curable lacquer onto said wear layer between the step of providing at least said decorative layer and said wear layer onto said substrate and the step of embossing, adherence between the several layers may be improved. More in particular, by having a separate lamination step of the decorative layer and the wear layer onto the substrate material, subsequently providing the curable lacquer onto said wear layer, and subsequently embossing said curable lacquer, adherence between the several layers may be improved.

According to a third possibility, said curable lacquer is provided onto said wear layer by means of a transfer film containing said curable lacquer. The transfer film is preferably a temporary carrier for the curable lacquer which may be disposed of after the transfer of said curable lacquer to said wear layer. According to a special embodiment the transfer film may remain as e.g. a topmost layer in the obtained decorative panels, wherein such transfer film may serve as a protective packaging aid which is to be removed for example upon installation of the decorative panel. Applying the curable lacquer by means of a transfer film may allow to set the thickness of the curable lacquer accurately and/or may allow that the transfer film containing the curable lacquer is prepared beforehand and/or offline. By preference, the curable lacquer may be at least partly precured onto the transfer film prior to applying it onto the wear layer. In such case the coating is preferably at least a radiation curable lacquer, such as a UV curable lacquer, and is cured preferably by means of radiation, such as UV curing.

According to a fourth possibility, said curable lacquer is provided onto said wear layer during the step of embossing said curable lacquer. By directly applying the curable lacquer during embossing, the curable lacquer may be applied in an uncured state, thereby minimizing the risk of cracking due to embossing in a partly precured lacquer.

Preferably, said curable lacquer has a thickness on said wear layer of between 10 and 800 um, even more preferably between 50 and 300 μm. Within said thickness range, the curable lacquer has sufficient thickness to provide improved scratch and/or wear resistance, while still allowing optimal transparency of the combined curable lacquer and wear layer.

Preferably, said step of embossing said curable lacquer is executed with said lacquer in uncured or semi-cured, i.e. precured, condition. It is clear that in such case one or more further curing steps may be necessary to reach the finally cured condition of said curable lacquer subsequent to said embossing.

Preferably, said curable lacquer is a thermally curable and/or radiation curable lacquer. In the case of a radiation curable lacquer this may be an excimer curable and/or UV curable lacquer and/or an LED curable lacquer, in particular UV LED. Thermally curable and radiation curable lacquers, such as excimer curable and/or UV curable lacquers, are easy to apply in their non-cured state, while forming a solid layer having good scratch and/or wear resistance once cured. Furthermore, curing by means of heat, excimer and/or UV is easy to implement in an existing production line and offers a lot of flexibility. In particular, the curable lacquer may be at least partly cured immediately after application, and preferably before said embossing, or may be wholly or finally cured before, during and/or after embossing. It is noted that a partial or final curing of a radiation and/or thermally curable lacquer during embossing can be obtained in several manners. In the case of an at least thermally curable lacquer the curing can be obtained by embossing with a heated press element. In the case of an at least radiation curable lacquer the curing can be obtained by embossing with a transparent press element and irradiating the radiation curable lacquer through said transparent press element. An example of a technique that could be applied in this latter case is disclosed in EP 2 927 017.

By preference, said curable lacquer is a two-stage curable lacquer, one stage being thermally curable, another stage being radiation, e.g. excimer and/or UV, curable. This has the particular advantage that the curable lacquer may be applied in its uncured form allowing easy application, may be partly precured before and/or during embossing thereby improving the embossment quality, and/or may be cured in its second stage immediately after embossing. This may not only allow improving efficiency of the manufacturing process, but may also improve the quality of the relief obtained by embossing, as well as the scratch and/or wear resistance of the finally cured lacquer.

According to a further or another embodiment, said curable lacquer is partly, at least partly or wholly cured, for example precured, onto said wear layer before the step of providing at least said decorative layer and said wear layer onto said substrate material, or before the step of embossing said curable lacquer. By precuring said curable lacquer before the step of providing at least said decorative layer and said wear layer onto the substrate material, the combination of the curable lacquer and the wear layer as actually conditioned as to allow offline storage, for example on a roll. This may further simplify the manufacturing process and/or improve efficiency thereof. By precuring said curable lacquer before the step of embossing said curable lacquer, the quality of the structure and/or relief obtained during embossing may furthermore be of improved quality and/or may be visually enhanced.

In some embodiments, said curable lacquer is at least partly precured prior to said step of embossing by means of UV curing. In some embodiments, said curable lacquer is at least partly cured during said step of embossing, preferably hot embossing. By varying the curing before, during and/or after embossing, different visual effects may be obtained.

According to a further or another embodiment, said curable lacquer comprises two or more lacquer layers, said lacquer layers preferably having a different gloss degree.

According to a further or another embodiment, said wear layer is provided with a thermoplastic primer in between said wear layer and said curable lacquer. The thermoplastic primer may allow better adhesion of the curable lacquer onto the wear layer and/or may further improve the scratch and/or wear resistance of the combined wear layer, thermoplastic primer and curable lacquer. An example of a suitable thermoplastic primer is a primer comprising PVAc (Polyvinyl Acetate). A further advantage of applying a thermoplastic primer mainly applies when the relief obtained by embossing is substantially deep, for example with a relief comprising embossment with a depth of at least 200 μm, or of 300 μm and deeper. The relief obtained by embossing may be only present in the curable lacquer, or may even extend to below the curable lacquer, thereby partly perforating the curable lacquer. In the latter case, the thermoplastic primer may penetrate through such perforations out onto the surface of the decorative panel, which may allow specific visual effects and/or may further improve the scratch and/or wear resistance.

In some embodiments, said step of providing at least said decorative layer and said wear layer onto said substrate material, and the step of embossing said curable lacquer on said wear layer is performed at the same time. By performing said steps at the same time, no separate lamination roller is needed, which may further simplify the manufacturing process. The decorative layer and the wear layer may be laminated together, or not, before being applied to said substrate material. Preferably, the decorative layer and the wear layer are laminated on said substrate material by means of an embossing roller. It is preferred that the decorative layer, the wear layer, the applied thereon curable lacquer and/or the substrate material follow the contour of the embossing roller over a portion of the circumference thereof that corresponds to an angular section of at least 45°, or an angular section between 65° and 90°. With such embodiment a good lamination may be obtained in combination with a high resolution in embossing.

As explained in the example directly above, said step of providing at least said decorative layer and said wear layer onto said substate material, and the step of embossing said curable lacquer on said wear layer may be performed by means of a single lamination/embossing roller. The manufacturing line may thus be further simplified.

According to a further or another embodiment, said curable lacquer is provided onto said wear layer by means of a roller coater, such as by means of a lick roller, a comma bar coater or a meyer bar coater. Alternatively, said curable lacquer may be provided onto said wear layer by means of a curtain coater or a slot coater. Applying the curable lacquer by means of a roller coater, a curtain coater or a slot coater allows that the thickness of the curable lacquer may be set more accurately. It is clear that the application techniques mentioned here may be applied in said first possibility, as well as in said second possibility for applying said curable lacquer.

In accordance with the invention, and especially in connection to said fourth possibility of applying said curable coating, by preference, said curable lacquer has a thickness on said wear layer of between 10 and 200 μm, or even more preferably between 10 and 100 μm. Such thickness may allow sufficient scratch and/or wear resistance while obtaining good transparency of the combined curable lacquer and wear layer. Herein, alternatively by preference, said curable lacquer may have a thickness on said wear layer of between 200 and 800 μm, between 300 and 800 μm, or between 500 and 800 μm. This is particularly advantageous in case substantially deep embossment structures are desired, for example with a relief comprising embossments with a depth of at least 200 μm, or of 300 μm and deeper. In general, but in the case of the fourth possibility particularly, by applying the curable lacquer in an uncured state, the risk of cracking due to embossing in a partly precured lacquer is minimized. It may however be possible that the curable lacquer is partly cured before embossing.

According to a further or another embodiment, said curable lacquer is an excimer curable and/or UV curable lacquer. This provides for that the curable lacquer can be cured in a simple manner and a good degree of crosslinking can be obtained. This has a positive influence on the mechanical and chemical resistance. Furthermore a curing step with excimer may lead to a surface with low gloss, such as with a degree of gloss of 8 or below as measured in accordance with DIN 67530. According to a special preferred embodiment said curable lacquer is cured by means of at least two curing steps. According to a first embodiment thereof, a first curing step is an excimer curing step and a subsequent second curing step is a UV curing step. In so doing the excimer cure may create the desired gloss or matt level at the surface, while the UV cure may then cure the deeper lying portions of the curable lacquer layer. According to a second embodiment thereof, a first curing step is a radiation curing step and a subsequent second step is a thermal curing step. In so doing, the radiation cure, e.g. UV cure, may lead to a low or not tack surface which is easy to handle in production, while the thermal curing step may be applied as the final curing step before, during or after embossing.

According to some embodiments, said curable lacquer is colored and/or stained. By using a colored and/or stained curable lacquer, a visual effect may be obtained wherein preferably certain coloring corresponds with the relief obtained by embossing.

According to some embodiments, said curable lacquer, before providing it onto said wear layer, is applied onto an embossing roller used during the step of embossing said curable lacquer. By directly applying the curable lacquer on the embossing roller, the lacquer can be easily applied and accurately dosed.

According to some embodiments, said curable lacquer is applied onto said embossing roller by means of a roller coater, such as a lick roller, a comma bar coater or a meyer bar coater. Alternatively a curtain coater or a slot coater may be used to apply said curable lacquer onto said embossing roller. Applying the curable lacquer by means of a roller coater, such as a lick roller, a curtain coater or slot coater allows that the thickness of the curable lacquer may be set more accurately.

According to a further or another embodiment, said curable lacquer is final cured after said step of embossing said curable lacquer by means of excimer and/or LED and/or EB (electron beam) curing and/or UV (ultraviolet) curing. This provides for that the curable lacquer can be cured in a simple manner and a good degree of crosslinking can be obtained. This has a positive influence on the mechanical and chemical resistance. Notwithstanding the curable lacquer being at least partly precured or not, final curing the curable lacquer after the step of embossing may allow to obtain a relief of high quality and/or may improve the scratch and/or wear resistance.

In some embodiments, after final curing said curable lacquer, an additional curable lacquer may be applied. Preferably, in such case, a primer, more particularly an adhesion primer, is provided on the cured lacquer, i.e. in between said additional curable lacquer and said curable lacquer. Such primer may provide an enhanced adherence of said additional curable lacquer on the cured lacquer. Alternatively, said additional curable lacquer is applied on the not yet fully cured, semi-cured, or uncured curable lacquer. In such case a good adherence may be obtained in the absence of primer layers, although the use of a primer is not excluded in such case as well. By applying an additional curable lacquer, scratch and/or wear resistance may be further improved, or specific visual effects may be obtained. To this aim, the additional curable lacquer preferably is provided after the relief is formed. Then, the additional curable lacquer in fact does not have to be embossed, such that, for example, a harder lacquer material can be chosen.

In some embodiments, the additional curable lacquer may have a gloss degree which is different from the curable lacquer, and/or the additional curable lacquer may be cured using another technique, thereby obtaining specific visual effects.

According to a special embodiment, said additional curable lacquer is an excimer curable lacquer. Such additional lacquer layer allows to set the gloss or mat level of the finally obtained surface of the decorative panel.

By preference, said additional curable lacquer is applied on the full surface of the curable lacquer, and, in particular by preference also in any embossments contained in said curable lacquer. As such, the additional curable lacquer may further improve the scratch and/or wear resistance.

Preferably, said additional curable lacquer comprises particles, preferably particles of Al2O3, SiC, SiO2 or the like, wherein the particles contained in said additional curable lacquer have a particle size distribution with a D50, preferably a D90 value of 40 μm or less. Such small particles give exceptional scratch resistance at the surface of the decorative panel obtained. Preferably, either particles are absent from the curable lacquer, or, particles, preferably particles of Al2O3, SiC, SiO2 or the like, are present in said curable lacquer, wherein the particles contained in said curable lacquer have a particle size distribution with a D90, preferably a D50 value larger than 40 μm, or even larger than 60 μm.

Preferably, said additional curable lacquer has a thickness smaller than the thickness of said curable lacquer. Preferably said additional curable lacquer has a thickness equalling or smaller than half the thickness of said curable lacquer. For example the curable lacquer may have a thickness of 80 to 300 μm, while the additional curable lacquer has a thickness of 40 μm or less.

In any case, it is preferred that the additional curable lacquer is different or discernible, e.g. by visual inspection possibly by means of a microscope, from the curable lacquer layer at least because of one or a combination of two or more of the following properties:
the property that the curable lacquer and the additional curable lacquer comprise different cross-linkable resins. For example said curable lacquer may comprise a multifunctional acrylate monomer and/or oligomer, while said additional curable lacquer layer may comprise a methacrylate;
the property that the curable lacquer and the additional curable lacquer comprise at least a portion of an identical or similar cross-linkable resin, for example both comprising a multifunctional acrylate monomer or oligomer, but wherein the respective portions are mutually different. For example, the resin of the curable lacquer may for at least 75 wt % consist out of a multifunctional acrylate monomer or oligomer, while the resin of the additional lacquer may for 70 wt % or less consist out of the same multifunctional acrylate monomer or oligomer;
the property that the curable lacquer and the additional curable lacquer comprise different initiators for crosslinking or a different initiator mix.
the property that the curable lacquer and the additional curable lacquer have a different content of particles. For example, the additional curable lacquer may comprise particles of Al2O3, SiC, SiO2 or the like, while such particles are absent or substantially absent from said curable lacquer. Such particles may bring additional scratch and wear resistance to the surface of the obtained decorative panels. Alternatively or in combination, the particles, preferably particles of Al2O3, SiC, SiO2 or the like, contained in said additional curable lacquer may show a particle distribution with a D50 value smaller than, preferably less than 90% of, the D50 value of the particle distribution of particles contained in the curable lacquer. Alternatively or in combination, as expressed in grams per square meter, the curable lacquer comprises more particles, preferably particles of Al2O3, SiC, SiO2 or the like, than said additional curable lacquer.

According to some embodiments, said embossing step defines deformed portions and undeformed portions in the surface of the curable lacquer, wherein, alternatively by preference, said additional curable lacquer is only applied on the undeformed portions. This is particularly advantageous in case a curable lacquer and an additional curable lacquer with a different gloss degree are used and/or in case these are cured using another technique. Special effects may be obtained, where the curable lacquer is visible at least in the deepest embossments, or deformed portions, and the additional lacquer is visible at least on the global upper surface, or undeformed portions.

According to some embodiments, said additional curable lacquer is cured via excimer and/or LED, such as UV LED, and/or electron beam (EB) and/or UV (Ultraviolet) curing. This provides for that the curable lacquer can be cured in a simple manner and a good degree of crosslinking can be obtained. This has a positive influence on the mechanical and chemical resistance. In particular, the additional curable lacquer is curable by means of excimer radiation, preferably followed by UV cureing. This allows obtaining a matte finish.

Said curable lacquer and said additional curable lacquer preferably are cured together. It is clear that in such case said curable lacquer is not yet fully cured, semicured, or uncured when applying said additional curable lacquer. This is advantageous in view of the fact that then only one curing station will have to be provided to this aim. Moreover, this common curing provides for that a mutual crosslinking can occur between the lacquer layers. This is beneficial for features, such as adherence, wear resistance, scratch resistance and stain resistance.

However, it may also be possible that the curable lacquer and the additional curable lacquer are cured separately. In that case, it can be chosen for curing both layers with a different technique, for example, the one with UV radiation and the other with excimer radiation, potentially followed by UV radiation. This may be especially advantageous in respect to obtaining a difference in gloss degree.

According to a further or another embodiment, said curable lacquer is realized on the basis of a polyurethane dispersion or acrylate dispersion and/or a combination of both. This results in that the lacquer layer can be embossed in a simple manner. By preference, the solid matter content of the PU and/or acrylate dispersion is situated between 30% and 50%, or even more preferably between 30% and 40%.

According to a further or another embodiment, said curable lacquer comprises an acrylate copolymer. Such copolymer provides extra flexibility.

The embossed lacquer layer may comprise a crosslinker. An example of a suitable crosslinker is polyaziridine and/or isocyanate.

The curable lacquer may comprise one or more photo-initiators and/or thermo-initiators.

According to the most preferred embodiment, said curable lacquer is an acrylate resin or unsaturated polyester resin, comprising at least one or more thermo-initiators, e.g. an organic peroxide, preferably benzoyl peroxide or lauryl peroxide or tertiary butylperoxyl-3,5,5-trimethylhexanoate (TBPIN). Preferably said curable lacquer comprises 0.1-5 parts by weight of thermo-initiator per 100 parts of said acrylate or unsaturated polyester resin. The curable lacquer may further comprises 0.1 to 5 parts by weight of photo-initiator. In the case of an acrylate resin, such resin preferably comprises a multifunctional acrylate monomer and/or oligomer, such as a hexafunctional acrylate oligomer, and, preferably said acrylate resin is of the aliphatic type. For example, such resins as disclosed in WO 2020/095196 may be applied as said curable lacquer.

According to a special embodiment, said curable lacquer is a full radiation curable resin. Herein it is meant that said resin is free or essentially free of thermo-initiators, and mainly or only comprises photo-initiators. With such resin or curable lacquer it is possible to prepolymerise the lacquer with UV, to subsequently emboss, and thereafter fully cure said resin or lacquer with UV. Such lacquer has the advantage that the risk of reactions during thermal lamination and/or embossing is minimized or non-existent, and a good copy of the structure of the embossing element, e.g. the embossing roller, can be expected. With such resin cold embossing, i.e. using an embossing element that is not heated, is possible.

In some embodiments, said curable lacquer is substantially free of solid particles. By using a curable lacquer of substantial thickness according to the invention, solid particles can be omitted, however while still obtaining good scratch and/or wear resistance. According to an alternative, said curable lacquer and/or said additional lacquer, when available, may comprise particles of Al2O3, SiC, SiO2 or the like. Such particles may bring about an exceptional abrasion and/or scratch resistance.

Preferably, said wear layer is transparent or translucent. This may allow good visibility of the decorative layer.

Preferably, said curable lacquer, preferably also after curing, is transparent or translucent. This may further improve the visibility of the decorative layer through the combined wear layer and curable lacquer.

In some embodiments, said decorative layer is colored and/or comprises a first printed pattern. Preferably, said decorative layer is a prefabricated thermoplastic foil or paper carrying a printed pattern. The printed pattern may be obtained by means of digital inkjet printing. According to an alternative said decorative layer is formed by direct application of inks on the substrate material, with the potential intermediate of one or more primer layers. The application of inks may be executed in a digital manner, for example by means of digital inkjet printing.

According to a further or another embodiment, at least a part of said wear layer comprises a second printed pattern. As such the first printed pattern and the second printed pattern may cooperate as to obtain an enhanced visual effect on different levels, which are visible through the wear layer and the curable lacquer on the surface of the decorated panel.

According to a further or another embodiment, said method comprises an additional embossing step, said additional embossing step is performed after said embossing step, and preferably after said step of applying the additional curable lacquer.

In some embodiments, said embossing step and/or said additional embossing step is performed in register with the first printed pattern of the decorative layer and/or with the second printed pattern of the wear layer. Such embossment in register with either the first printed pattern or the second printed pattern, or with both patterns, may further result in a visually very realistic decorated panel.

It may be possible that only a single substrate layer is provided. It may also be possible that multiple substrate layers are provided. The one or more substrate layers can be formed in any suitable manner. For example, strewing, extrusion and/or calendaring techniques are employed. The first-mentioned technique can be employed with wood-based as well as with thermoplastic substrate layers. The two last-mentioned techniques are primarily useful with thermoplastic substrate layers. By preference, said one or more substrate layer comprises a thermoplastic material.

With the same aim as in said first independent aspect, the present invention, in accordance with its second independent aspect is a decorative panel, which comprises a substrate layer, a decorative layer, a wear layer provided above said decorative layer, and a lacquer layer provided above said wear layer, wherein the decorative panel has an upper surface showing a relief, said relief is present in at least the lacquer layer, wherein the thickness of said wear layer and the thickness of said lacquer layer follow a ratio of between 5:1 and 1:25.

It is clear that the decorative panel of said second independent aspect may be obtained through a method in accordance with the first aspect of the invention and/or the preferred embodiments thereof, and that, as a result, the decorative panel of said second aspect may show corresponding preferred embodiments as mentioned in connection with said first aspect without necessarily having been manufactured in accordance with the first aspect.

The invention in its second aspect may have one or more advantages over what is known in that by having the above-mentioned ratio, a thinner wear layer may be applied. Using a thinner wear layer may have the advantage that transparency is improved, thus making the decorative layer underneath better visible at the surface of the decorative panel. Furthermore, by combining a wear layer and a lacquer layer following the above-mentioned ratio, at least the same scratch and/or wear resistance, or an even improved scratch and/or wear resistance, may be obtained in comparison to wear layers which are known in the art. As the relief is at least, and preferably only, present in the lacquer layer, the risk may furthermore be reduced of having uncoated spots on the surface of the decorative panel, and gloss of the surface of the decorative panel may be determined by the lacquer layer and/or by the embossment structure or relief.

By preference, the thickness of said wear layer and the thickness of said lacquer layer follow a ratio of between 4:1 and 1:20, more by preference of between 3:1 and 1:15, even more by preference of between 2:1 and 1:10, most by preference of between 1:1 and 1:10. With increased preferability, the transparency is further improved while still maintaining at least the same scratch and/or wear resistance, or while even improving the scratch and/or wear resistance.

By preference, said lacquer layer has a thickness on said wear layer of between 10 and 800 μm, preferably between 50 and 300 μm. Within said thickness range, the lacquer layer has sufficient thickness to provide improved scratch and/or wear resistance, while still allowing optimal transparency of the combined curable lacquer and wear layer. Decorative panels comprising substantially thick lacquer layers, by preference having a thickness of between 10 and 800 μm, or between 50 and 300 μm, is to be regarded as an independent aspect of the invention as well. In particular, such lacquer layers may even be present directly above the decorative layer, meaning the wear layer may be omitted. It is clear that visibility of the decorative layer may be vastly improved, yielding a decorative panel of high quality. By using the substantially thick lacquer layer, at least the same or even improved scratch and/or wear resistance may be obtained in comparison to what is known. Such decorative panel may be defined as a decorative panel, which comprises a substrate layer, a decorative layer, and a lacquer layer provided above said decorative layer, preferably directly above and adjacent thereto, wherein the decorative panel preferably has an upper surface showing a relief, said relief is present in at least the lacquer layer, wherein the panel shows at least one of the following properties:
the property that said lacquer layer has a thickness of at least 100 μm, or at least 150 μm;
the property that said lacquer layer has a thickness of between 10 and 800 μm;
the property that said lacquer layer has a thickness of between 50 and 800 μm;
the property that said lacquer layer has a thickness of between 50 and 300 μm; or
the property that said lacquer layer has a thickness of between 300 and 800 μm;
the property that said decorative layer comprises a printed pattern applied to a thermoplastic foil, and, preferably the thickness of said thermoplastic foil and said lacquer layer follow a ratio of between 5:1 and 1:50, preferably between 5:1 and 1:25;
the property that said decorative panel is free from polyvinyl chloride in the portion of said panel that is positioned above said decorative layer.
   It is clear that such decorative panel may be obtained with a method similar to the method of the first aspect and/or the preferred embodiments thereof without necessarily applying said wear layer. For example, the components, for example acrylate resins, unsaturated polyester resins, thermo-initiators and/or photo-initiators listed in the context of the first aspect for said curable lacquer may also be applied in the present decorative panel. The additional lacquer layers mentioned in the first aspect may also be applied.

According to a further or another embodiment, said lacquer is a thermally curable and/or radiation curable lacquer, such as an excimer curable, LED curable, EB curable and/or UV curable lacquer. Thermally curable and radiation curable lacquers, such as excimer curable and/or UV curable lacquers, are easy to apply in their non-cured state, while forming a solid layer having good scratch and/or wear resistance once cured. Furthermore, curing by means of heat, excimer and/or UV is easy to implement in an existing production line and offers a lot of flexibility. In particular, the lacquer may be at least partly cured immediately after application, or may be cured before, during and/or after embossing

According to a further or another embodiment, said lacquer is a two-stage curable lacquer, one stage being thermally curable, another stage being radiation curable, e.g. excimer and/or UV curable. This has the particular advantage that the lacquer may be applied in its uncured form allowing easy application, may be partly precured before and/or during embossing thereby improving the embossment quality, and/or may be cured in its second stage immediately after embossing. This may not only allow improving efficiency of the manufacturing process, but may also improve the quality of the relief obtained by embossing, as well as the scratch and/or wear resistance of the finally cured lacquer.

According to a further or another embodiment, said lacquer comprises two or more lacquer layers, said lacquer layers preferably having a different gloss degree.

According to some embodiments, said decorative panel comprises a thermoplastic primer in between said wear layer and said lacquer layer. The thermoplastic primer may allow improved adherence between the wear layer and the lacquer layer. In some embodiments, the lacquer layer may at least partly protrude the lacquer layer, in particular in case the lacquer layer is locally interrupted, and preferably the thermoplastic primer protrudes up to the surface of the decorative panel.

According to some embodiments, said lacquer layer has a thickness on said wear layer of between 50 and 300 μm, of between 10 and 100 μm, or of between 300 and 800 μm or of between 500 and 800 μm.

Decorative panels comprising substantially thick lacquer layers, by preference having a thickness of between 50 and 300 μm, are, as mentioned above, to be regarded as an independent aspect of the invention as well. In particular, such lacquer layers may even be present directly above the decorative layer, meaning the wear layer may be omitted. It is clear that visibility of the decorative layer may be vastly improved, yielding a decorative panel of high quality. By using the substantially thick lacquer layer, at least the same or even improved scratch and/or wear resistance may be obtained in comparison to what is known.

It may be that the lacquer has a thickness on said wear layer of between 10 and 100 μm. Such thickness may allow sufficient scratch and/or wear resistance while obtaining good transparency of the combined lacquer and wear layer. Herein, alternatively by preference, said lacquer may have a thickness on said wear layer of between 300 and 800 μm or between 500 and 800 μm. This is particularly advantageous in case substantially deep embossment structures are desired. In this case particularly, the decorative panels of the invention may be efficiently made. In particular, the risk of cracking due to embossing in a partly precured lacquer is minimized. It may however be possible that the lacquer is partly cured before embossing.

According to some embodiments, said lacquer is colored and/or stained. By using a colored and/or stained curable lacquer, a visual effect may be obtained wherein certain coloring corresponds with the relief obtained by embossing.

According to a further or another embodiment, said decorative panel comprises an additional lacquer layer. By having an additional lacquer, scratch and/or wear resistance may be further improved, or specific visual effects may be obtained. To this aim, the additional lacquer preferably is provided after the relief is formed. Then, the additional lacquer in fact does not have to be embossed, such that, for example, a harder lacquer material can be chosen.

By preference, said additional lacquer layer is present on the full surface of the lacquer layer. As such, the additional curable lacquer may further improve the scratch and/or wear resistance. A primer may be available between said lacquer layer and said additional lacquer layer.

According to some embodiments, said relief comprises deformed portions and undeformed portions on the surface of the lacquer layer, and wherein said additional lacquer is only applied on the undeformed portions. This is particularly advantageous in case a lacquer and an additional lacquer with a different gloss degree are used and/or in case these are cured using another technique.

According to some embodiments, said additional lacquer layer is an excimer curable and/or UV curable lacquer.

According to some embodiments, said lacquer layer is realized on the basis of a polyurethane dispersion or an acrylate dispersion or a combination of both. By preference, the solid matter content of the PU and/or acrylate dispersion is situated between 30% and 50%, preferably between 30% and 40%.

According to some embodiments, said lacquer layer comprises an acrylate copolymer. Such copolymer provides extra flexibility.

According to some embodiments, said lacquer layer is substantially free solid particles. By using a lacquer of substantial thickness according to the invention, solid particles can be omitted, however while still obtaining good scratch and/or wear resistance.

According to some embodiments, said wear layer is transparent or translucent. This may further improve the visibility of the decorative layer through the combined wear layer and curable lacquer.

According to a further or another embodiment, said lacquer layer is transparent or translucent. This may further improve the visibility of the decorative layer through the combined wear layer and curable lacquer.

According to some embodiments, said decorative layer is colored and/or comprises a first printed pattern.

According to some embodiments, at least a part of said wear layer comprises a second printed pattern. As such the first printed pattern and the second printed pattern may cooperate as to obtain an enhanced visual effect on different levels, which are visible through the wear layer and the curable lacquer on the surface of the decorated panel.

According to a further or another embodiment, said relief is in register with at least the first printed pattern of the decorative layer. Such embossment in register with at least the first printed pattern may further result in a visually very realistic decorated panel.

It may be possible that the decorative panel only comprises a single substrate layer. It may also be possible that multiple substrate layers are provided. By preference, said one or more substrate layer comprises a thermoplastic material.

It is noted that a method comprising a step of applying a substantially thick curable lacquer, by preference having a thickness of between 50 and 800 μm, preferably between 50 and 300 μm, as such forms an inventive idea. Preferably said thickness is at least 100 μm or at least 150 μm. In particular, such a curable lacquer may even be applied directly onto the decorative layer, meaning the wear layer may be omitted. It is clear that visibility of the decorative layer may be vastly improved, yielding a decorative panel of high quality. By applying the substantially thick curable lacquer, at least the same or even improved scratch and/or wear resistance may be obtained in comparison to what is known. Thus, the invention, according to a third independent aspect, also relates to a method of manufacturing a decorative panel, comprising the steps of:
providing a substrate material,
providing at least a decorative layer onto said substrate material,
providing a curable lacquer on said decorative layer, and
embossing at least said curable lacquer,
   wherein said curable lacquer has a thickness on said decorative layer of between 50 and 800 μm, preferably between 50 and 300 μm.

Preferably, the thickness of said curable lacquer after final curing is at least 100 μm or at least 150 μm.

Also, a fourth independent aspect of the invention concerns a decorative panel, which comprises a substrate layer, a decorative layer, and a lacquer layer provided above said decorative layer, wherein the decorative panel preferably has an upper surface showing a relief, said relief is present in at least the lacquer layer, wherein said lacquer layer has a thickness on said decorative layer of between 50 and 800 μm, or between 50 and 300 μm. Preferably said lacquer layer has a thickness of at least 100 μm or at least 150 μm.

Preferably, the panel shows at least one of the following properties:
the property that said lacquer layer has a thickness of at least 100 μm, or at least 150 μm;
the property that said lacquer layer has a thickness of between 10 and 800 μm;
the property that said lacquer layer has a thickness of between 50 and 800 μm;
the property that said lacquer layer has a thickness of between 50 and 300 μm; or
the property that said lacquer layer has a thickness of between 300 and 800 μm;
the property that said decorative layer comprises a printed pattern applied to a thermoplastic foil, and, preferably the thickness of said thermoplastic foil and said lacquer layer follow a ratio of between 5:1 and 1:50, preferably between 5:1 and 1:25;
the property that said decorative panel is free from polyvinyl chloride in the portion of said panel that is positioned above said decorative layer.
   It is clear that such decorative panel may be obtained with a method similar to the method of the first aspect and/or the preferred embodiments thereof without necessarily applying said wear layer. For example, the components, for example acrylate resins, unsaturated polyester resins, thermo-initiators and/or photo-initiators listed in the context of the first aspect for said curable lacquer may also be applied in the present decorative panel. The additional lacquer layers mentioned in the first aspect may also be applied.

According to the most preferred embodiment of said fourth independent aspect, said decorative panel shows the following features in combination:
said substrate layer comprises a thermoplastic material and potentially filler materials;
said decorative layer comprises a digitally printed pattern, either formed by directly applying inks on said substrate layer possibly with the intermediate of one or more primer layers, or formed on a carrier layer, such as thermoplastic foil or paper;
said decorative panel optionally comprises a wear layer in between said decorative layer and said lacquer layer, wherein said wear layer is preferably a prefabricated thermoplastic sheet, for example of polyvinyl chloride. Preferably such wear layer has a thickness of 50 to 150 μm, e.g. about 100 μm. It is clear that the decorative panel may also be free from layers, free from prefabricated layers and/or free from PVC, in between said decorative layer and said lacquer layer;
said lacquer layer is obtained from a thermo-curing and/or UV curing lacquer comprising multifunctional acrylate monomers or oligomers, wherein said lacquer layer has a thickness of at least 80 μm, or at least 150 μm. Preferably a relief is applied in said lacquer layer. Preferably said lacquer layer is essentially free from solid particles;
an additional lacquer layer is applied over said lacquer layer, wherein said additional lacquer layer is obtained from a thermo-curing and/or UV curing lacquer comprising multifunctional acrylate monomers or oligomers, wherein said additional lacquer layer has a thickness smaller than the thickness of said lacquer layer, preferably a thickness of 40 μm or less, wherein said additional lacquer layer preferably comprises particles, preferably particles of Al2O3, SiC, SiO2 or the like, wherein the particle size distribution of said particles has a D50 value or even a D90 value of 40 μm or less.

It is noted that, preferably, in the context of any of the aspects of the present invention, said decorative layer is a prefabricated thermoplastic foil or paper carrying a printed pattern. The printed pattern may be obtained by means of digital inkjet printing. According to an alternative said decorative layer is formed by direct application of inks on the substrate material, with the potential intermediate of one or more primer layers. The application of inks may be executed in a digital manner, for example by means of digital inkjet printing.

Where particle sizes, such as D50 value, and particle size distributions are discussed in the present disclosure, this preferably concerns particle sizes and distributions as defined by laser light granulometry performed in accordance with ISO 13320, namely by a dynamic light scattering technique using a laser having an emission wavelength of 632.8 nm and measured under a scattering angle of 90 degrees. Such granulometry may e.g. be performed with a Malvern® Mastersizer 2000 or with a Malvern® Mastersizer 3000. For executing the measurement of the particle size distribution, the respective particles may be dispersed in a liquid, such as water.

In order to better demonstrate the features of the invention, some preferred embodiments are described below, by way of example and without any limiting character, with reference to the accompanying drawings, wherein:

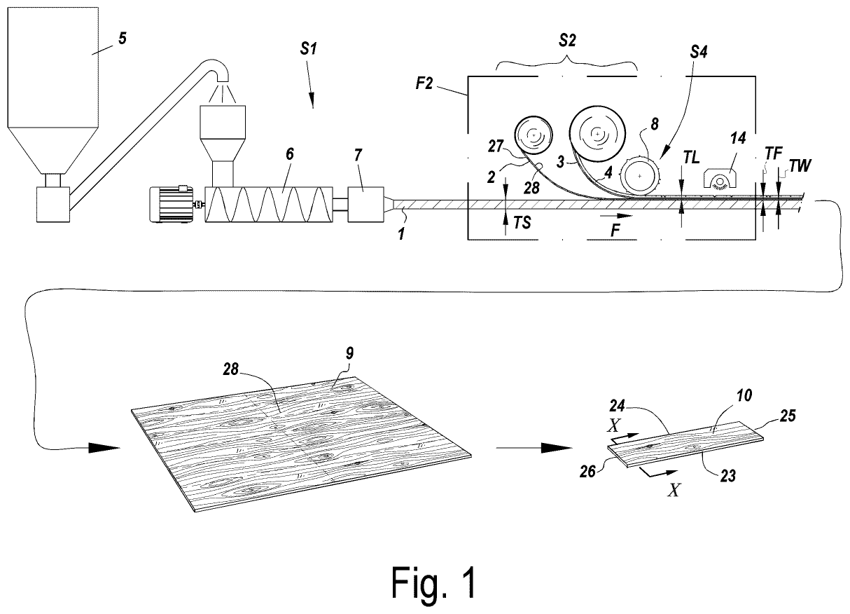

FIG. 1 schematically illustrates a method for manufacturing a decorative panel in accordance with the invention;

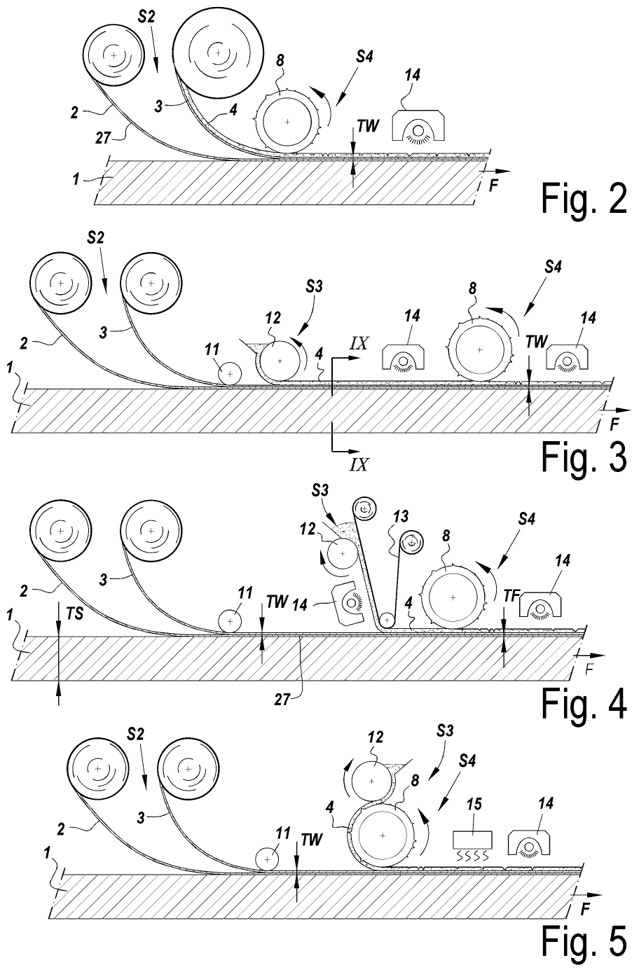

FIG. 2 schematically illustrates some steps in a method in accordance with the invention from the area F2;

FIGS. 3 to 8 in a same view as FIG. 2 represent variants;

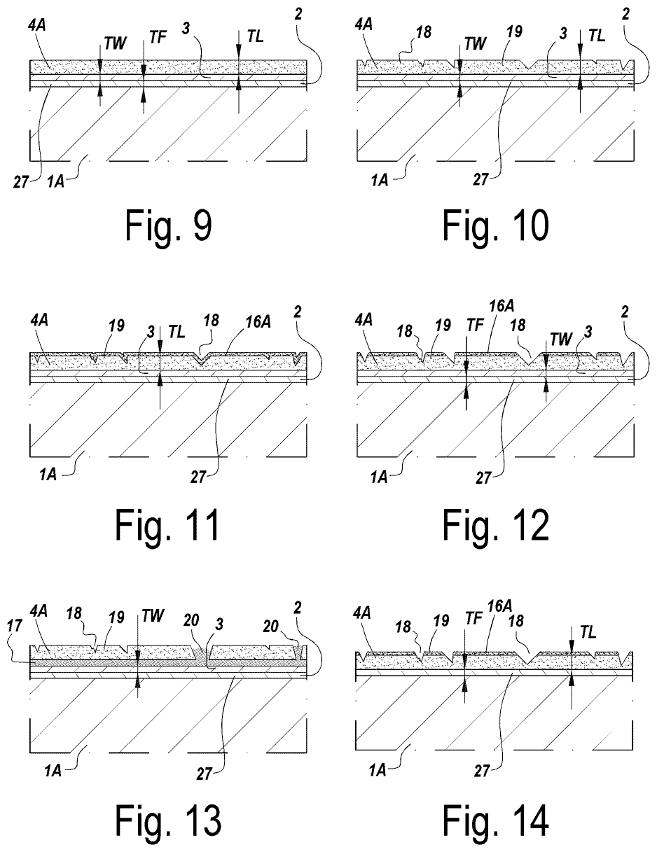

FIG. 9 illustrates a cross-section in accordance with line IX-IX in FIG. 3;

FIG. 10 illustrates a cross-section in accordance with line X-X in FIG. 1;

FIGS. 11 to 14 in a view similar to that of FIG. 10 illustrate variants; and

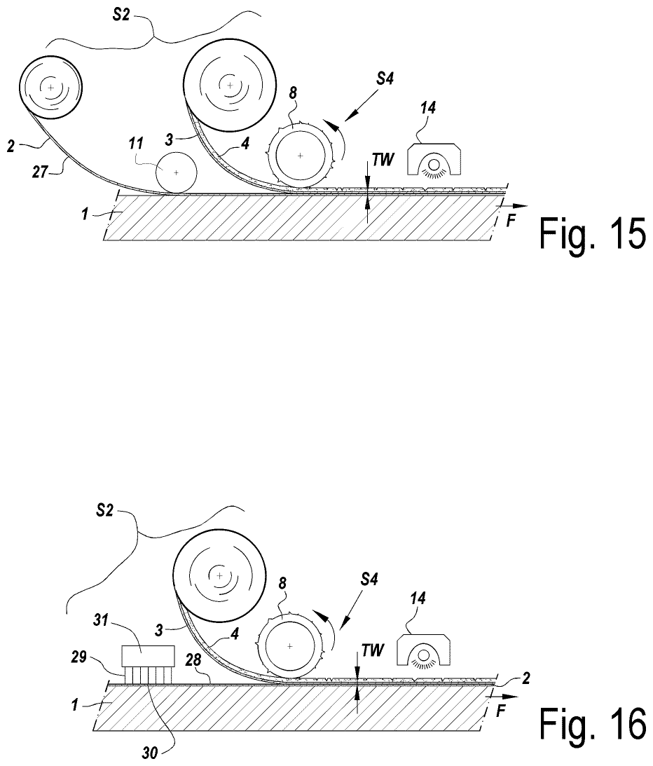

FIGS. 15 and 16 in a same view as FIG. 2 illustrate variants.

FIG. 1 shows a method for manufacturing a decorative panel 10 in accordance with the invention, comprising at least the step S1 of providing a substrate material 1, the step S2 of providing at least a decorative layer 2 and a wear layer 3 onto said substrate material 1, wherein said wear layer 3 is located above said decorative layer 2, the step S3, not shown, of providing a curable lacquer 4 on said wear layer 3, and the step S4 of embossing at least said curable lacquer 4, wherein the thickness TW of said wear layer 3 and the thickness TL of said curable lacquer 4 follow a ratio of between 5:1 and 1:25. As is shown in FIG. 1, providing of the substrate material 1 may be performed by an extrusion operation, which comprises a feed 5 for feeding raw material for the substrate material 1 to the extruder 6. The raw material is extruded through a so-called flat die or slot die 7 in to a flat substrate material 1, for example having a width of 1 to 2.1 meter, preferably about 1.3 meter and a thickness TS of 2 to 7 mm, by preference of 3 to 6 mm, more by preference of 3 to 5 mm, even more by preference of 3.5 to 4.5 mm. After leaving said slot die 7, the substrate material 1 continuously moves in a feeding direction F to be subjected to said steps S2-S4. It is furthermore shown in FIG. 1 that the resulting material may be further divided into slabs 9 comprising a plurality of decorative panels and/or consequently divided into decorative panels 10. In a subsequent step, not shown, these decorative panels may at one or more pairs of opposite edges 23-24-25-26 be provided with coupling means enabling a glueless floating installation of a plurality of such decorative panels 10 into a covering, such as a floor covering. The coupling means may be substantially or wholly formed in the substrate material 1 and/or said decorative layer 2, wear layer 3 and lacquer layer 4. The coupling means may basically be shaped as a tongue and groove connection comprising mechanical locking means preventing the drifting apart of the tongue and groove. Examples of such coupling means are for example disclosed in WO 2011/077311.

The decorative layer 2, in this case a thermoplastic foil 27 with an applied thereon printed pattern 28, has a thickness TF, wherein the thickness TF of said thermoplastic foil 27 and the thickness TL of said lacquer layer 4 follow a ratio of between 5:1 and 1:50, preferably between 5:1 and 1:25.

In the present example, as better shown in FIG. 2, said curable lacquer 4 is provided onto said wear layer 3 before the step S2 of providing at least said decorative layer 2 and said wear layer 3 onto said substrate material 1. Said curable lacquer 4 may have a thickness TL on said wear layer 3 of between 10 and 800 μm, preferably between 50 and 300 μm and/or may be a thermally curable and/or radiation curable, e.g. excimer curable and/or UV curable and/or LED curable and/or electron beam curable, lacquer. In the present example, preferably said curable lacquer 4 is thermally curable and UV curable. Preferably, said curable lacquer 4 is precured onto said wear layer 3 before the step S2 of providing at least said decorative layer 2 and said wear layer 3 onto said substrate material 1. Such precuring of the curable lacquer 4 on the wear layer 3 may be performed offline, and is not explicitly illustrated in FIG. 2. It is furthermore shown that said step S2 of providing at least said decorative layer 2 and said wear layer 3 onto said substrate material 1, and the step S4 of embossing said curable lacquer 4 on said wear layer 3 is performed at the same time. Herein, said step S2 of providing at least said decorative layer 2 and said wear layer 3 onto said substrate material 1, and the step S4 of embossing said curable lacquer 4 on said wear layer 3 is performed by means of a single lamination/embossing roller 8. Preferably, said embossing roller 8 is heated such that hot embossing of the curable lacquer 4 is obtained. The curable lacquer 4 is finally cured after embossing by means of the UV curing device 14. It is noted that the curable lacquer 4 may or may not comprise solid particles, such as abrasive particles.

FIGS. 3 and 4 represent variants wherein said curable lacquer 4 is provided onto said wear layer 3 between the step S2 of providing at least said decorative layer 2 and said wear layer 3 onto said substrate material 1, and the step S4 of embossing said curable lacquer 4. In these cases where the step S2 of providing the decorative layer 2 and the wear layer 3 onto the substrate material 1 are performed separately from the embossing step S4, one or more lamination rollers 11 may be provided, while embossing is performed by means of an embossing roller 8, preferably a heated embossing roller 8. Said curable lacquer 4 may have a thickness TW on said wear layer 3 of between 10 and 800 μm, preferably between 50 and 300 μm, and/or may be a thermally curable and/or radiation curable, e.g. excimer curable and/or UV curable lacquer. In the particular example of FIG. 3, it is shown that, said curable lacquer 4 may be precured onto said wear layer 3 before the step S4 of embossing said curable lacquer 4. It may herein be that said curable lacquer 4 is at least partly precured prior to said step S4 of embossing by means of a UV curing device 14. In the particular example of FIG. 3, the curable lacquer 4 is provided onto said wear layer 3 by means of a roller coater, more particularly a lick roller 12. As an alternative, in FIG. 4, it is shown that said curable lacquer 4 is provided onto said wear layer 3 by means of a transfer film 13 containing said curable lacquer 4. The curable lacquer 4 may be applied to the transfer film 13 by means of a roller coater, such as by means of a lick roller 12. It may be that the curable lacquer 4 is at least partly precured on the transfer film 13 before applying it on the wear layer 3, which may be done by means of a UV curing device 14. It is noted that the curable lacquer 4 may or may not comprise solid particles, such as abrasive particles.

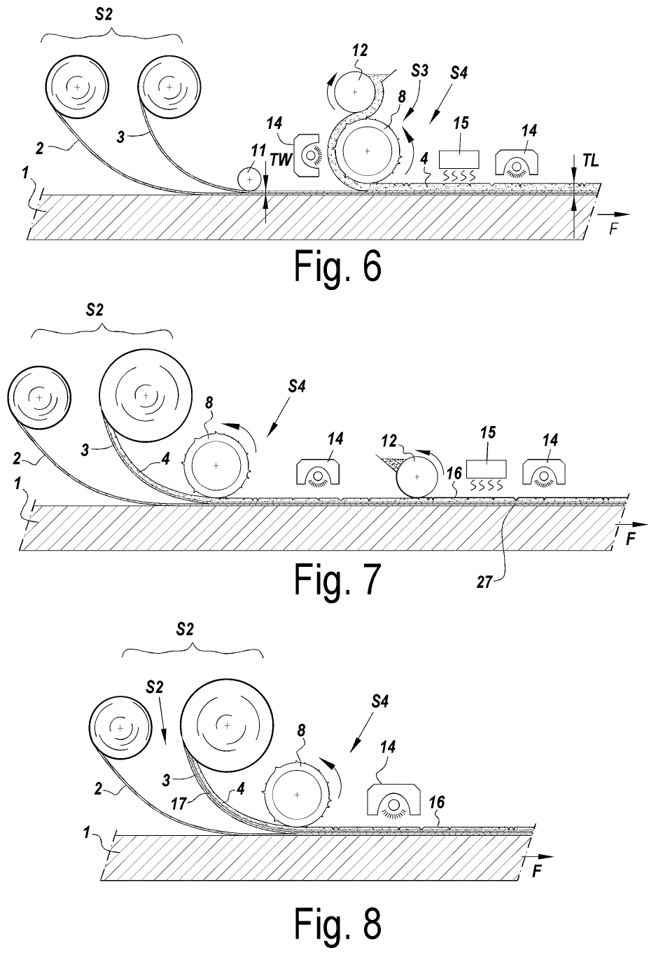

FIGS. 5 and 6 represent variants wherein said curable lacquer 4 is provided onto said wear layer 3 during the step of embossing said curable lacquer 4. Said curable lacquer may be relatively thinly applied, such as shown in FIG. 5, wherein said curable lacquer 4 has a thickness TL on said wear layer 3 of between 10 and 100 μm. Alternatively, said curable lacquer 4 may be relatively thickly applied, such as shown in FIG. 6, wherein said curable lacquer 4 has a thickness TL on said wear layer 3 of between 300 and 800 μm, preferably between 500 and 800 μm. In both cases, said curable lacquer 4, before providing it onto said wear layer 3, is applied onto an embossing roller 8 used during the step S4 of embossing said curable lacquer 4. Said curable lacquer 4 may herein be applied onto said embossing roller 8 by means of a lick roller 12. Optionally, as shown in FIG. 6, said curable lacquer 4 may be at least partly precured on the embossing roller 8 by means of a UV curing device 14, before finally applying it onto the wear layer 3. In the present examples, a pretreatment may be present on the wear layer 3, such as a UV primer or bulk UV coating. In each of the aforementioned variants, said curable lacquer 4 is preferably final cured after said step S4 of embossing said curable lacquer 4 by means of excimer and/or UV curing, which may be performed by a UV curing device 14 and/or an excimer curing device 15. It is clear that both options remain possible, either alone or in combination, in any of the variants as illustrated. In the present examples of FIGS. 5 and 6, the curable lacquer 4 may be colored and/or stained and may thus serve the purpose of obtaining special visual effects. In particular, using a colored and/or stained curable lacquer 4 may allow to obtain staining and/or texturing in register.

FIG. 7 represents a variant of the example as shown in FIG. 2, wherein after final curing said curable lacquer 4, an additional curable lacquer 16 is applied. It may be that said additional curable lacquer is applied on the full surface of the curable lacquer 4. Alternatively, it may be that the surface is only partly covered by the additional curable lacquer 16. The additional curable lacquer 16 may be applied by means of a roller coater, such as by means of a lick roller 12. Final curing may be done by means of UV curing 14 and/or excimer curing 15.

FIG. 8 represents a variant of the example as shown in FIG. 2, wherein a thermoplastic primer 17 is provided in between said wear layer 3 and said curable lacquer 4. The relief obtained by embossing may be only present in the curable lacquer 4, or may even extend to below the curable lacquer 4, thereby partly perforating the curable lacquer 4. In the latter case, the thermoplastic primer 17 may penetrate through such perforations out onto the surface of the decorative panel.

In each of the variants shown, it may be that said curable lacquer 4 comprises two or more lacquer layers, said lacquer layers preferably having a different gloss degree.

It is also possible that said curable lacquer 4 is applied in several substeps, which do not necessarily have to apply a same or similar application method. For example, a first portion of said curable lacquer 4 may be pre-applied to the wear layer 3, similar to that what is shown in FIG. 2, 7 or 8, while a second portion may be liquidly applied downstream from providing said wear layer 3 and decorative layer 2 on the substrate material 1, for example similar to that what is shown in FIG. 3, 4, 5 or 6.

FIG. 9 illustrates a cross-section according to line IX-IX which corresponds to the layered build-up of a substrate layer 1A, a decorative layer 2, a wear layer 3 and a lacquer layer 4A obtained from a curable lacquer 4 in accordance with the invention, wherein FIG. 9 shows the layered build-up before embossing at least said lacquer layer 4A, wherein the thickness TW of said wear layer 3 and the thickness TL of said curable lacquer 4 or lacquer layer 4A follow a ratio of between 5:1 and 1:25.

FIGS. 10 to 14 illustrate various cross-sections which correspond to the build-up of a decorative panel 10 in accordance with various embodiments of the invention. It is shown that the decorative panel 10 comprises a substrate layer 1A, a decorative layer 2, a wear layer 3 provided above said decorative layer 2, and a lacquer layer 4A provided above said wear layer 3, wherein the decorative panel 10 has an upper surface showing a relief, said relief is present in at least the lacquer layer 4A, wherein the thickness TW of said wear layer 3 and the thickness TL of said lacquer layer 4A follow a ratio of between 5:1 and 1:25. Preferably, said lacquer layer 4A has a thickness TL on said wear layer 3 of between 10 and 800 μm, preferably between 50 and 300 μm. FIG. 10 also shows the relief in the lacquer layer 4, comprising deformed portions 18 and undeformed portions 19.

FIG. 11 illustrates a variant that may be obtained through the method illustrated in FIG. 7, wherein an additional lacquer layer 16A is present, said additional lacquer layer 16A is present on the full surface of the lacquer layer 4A. In the alternative, FIG. 12 illustrates a variant wherein said relief comprises deformed portions 18 and undeformed portions 19 on the surface of the lacquer layer 4A, and wherein said additional lacquer 16A is only applied or mainly available on the undeformed portions 19.

FIG. 13 illustrates a variant that may be obtained through the method illustrated in FIG. 8, wherein the relief is substantially deep, and wherein at least some of the deformed portions 18 protrude throughout the lacquer layer 4A. In the present example, a thermoplastic primer 17 is present in between the wear layer 3 and the lacquer layer 4A. In those regions where the deformed portions 18 protrude throughout the lacquer layer 4A, the thermoplastic primer 17 is able to wholly or partially fill the interruptions 20 in the lacquer layer 4A.

FIG. 14 illustrates a decorative panel 10 which is mainly identical to the embodiment shown in FIG. 12, but where the wear layer 3 has been omitted. In so doing, an embodiment in accordance with the fourth independent aspect is obtained. The decorative panel 12 of FIG. 14 shows the preferred property that the lacquer layer 4A has a thickness TL of at least 150 μm. The decorative layer 2 comprises a printed pattern 28 applied to a thermoplastic foil 27. The thickness TF of the thermoplastic foil 27 and said lacquer layer 4A follow a ratio of about 1:2.5. The decorative panel 10 is free from polyvinylchloride in the portion of said panel 10 that is positioned above said decorative layer 2. The lacquer layer 4A is obtained from an acrylate resin, preferably an acrylate resin comprising 0.1 to 5 parts by weight of thermo-initiators and/or photo-initiators per 100 parts of acrylate. The additional lacquer layer 16A is obtained from the same acrylate resin, but, in contrast to the curable lacquer layer 4A, comprises particles wherein the particle size distribution of said particles has a D90 value of 40 μm or less. Particles are absent in said curable lacquer layer 4A.

It is clear that when the wear layer 3 of FIG. 11 were to be omitted that a similar embodiment as that of FIG. 14 could be obtained, but wherein the additional lacquer layer 16A covers the entire surface of the decorative panel 10. Such decorative panel 10 forms an example of the fourth independent aspect of the present invention.

It is noted that in the embodiments of the fourth independent aspect, e.g. the embodiment illustrated in FIG. 14, the decorative layer 2 can also be formed as illustrated in the further FIG. 16, namely by direct application of inks on the substrate material with the intermediate of one or more primer layers.

FIG. 15 illustrates some steps S2-S4 in a method for manufacturing decorative panels in accordance with the first independent aspect of the invention. FIG. 15 is essentially identical to FIG. 2 with this exception that the decorative layer 2 and the wear layer 3 are separately and subsequently provided on the substrate material 2. The decorative layer 2 is laminated to said substrate material 2 by means a lamination roller 11, which is separate and arranged upstream from the embossing roller 8 which provides said wear layer 3 on top of said already laminated decorative layer 2.

An additional lamination roller 11 for separate lamination of the decorative layer 2 upstream of the provision of said wear layer 3, may be available in any of the embodiments illustrated in FIGS. 2 to 8.

FIG. 16 illustrates another variant which is essentially identical to FIG. 2 with this exception that the decorative layer 2, instead of being a prefabricated thermoplastic foil 27 with an applied thereon printed pattern 28, is formed by direct application of inks 29 on the substrate material 1, more particularly with the intermediate of one or more primer layers 30 that are applied on said substrate material 1 upstream of the ink application. The application of inks is in this case, as schematically represented in FIG. 16, executed by means of a digital printer 31 of the single pass type.

The decorative layer 2 illustrated in any of the FIGS. 2 to 8, may be replaced by a decorative layer 2 comprising inks 29 directly applied to the substrate material 1, preferably with the intermediate of one or more primer layers 30, as illustrated in FIG. 15. In such case, and in particular in FIGS. 3, 4, 5 and 6 the wear layer 3 may be omitted, and the curable lacquer layer 4 may be applied directly on the decorative layer 2 comprising said inks 29 which are directly applied to the substrate material 1. In so doing, a method in accordance with the third independent aspect may be obtained. The thus manufactured decorative panels 10 form embodiments in accordance with the fourth independent aspect.

In general, with respect to the figures, it is noted that where an embossing roller 8 is applied, such embossing roller 8 may be replaced by an alternative pressing element, such as by a structure foil, a structured press belt or a structured press plate. Such alternative pressing element may be applied in a continuously operating press. Alternatively, and in particular when a structured press plate is applied, this may be applied in a discontinuously operated press, for example in a so-called single daylight or multiple daylight press. Upstream from such discontinuously operated press, said substrate material 1 and the applied thereon decorative layer 2 and/or wear layer 3 and/or curable lacquer layer 4 and/or additional lacquer layer 16 may be divided into slabs 9, such that the discontinuously operated press is active on one or more of said slabs 9.

It is further remarked that the additional embossing step mentioned in the introduction may be achieved by means of an embossing roller 8 or by means of an alternative pressing element, such as by one or more of the alternative pressing elements mentioned here directly above. The additional embossing step may be active on the substrate material 1 and the applied thereon decorative layer 2 and/or wear layer 3 and/or curable lacquer layer 4 and/or additional lacquer layer 16 while it is still in an endless format, or on slabs 9 obtained by dividing such endless substrate material 1. Such an additional embossing step may for example be applied for the formation of lowered areas which in the decorative panel 10 form lowered edge regions at one or more edges. Such lowered edge regions may for example comprise a beveled surface. Preferably, the curable lacquer layer 4A is available in said lowered edge region.

It is noted that, in the example of FIG. 8, the primer 17 is pre-applied on the wear layer 3, intermediate to the wear layer 3 and said curable lacquer 4. A primer 17 may be applied in any of the embodiments shown in the figures. In the cases of FIGS. 2, 7, 8, 15 and 16, the primer 17 may be pre-applied to the wear layer 3 intermediate the wear layer 3 and the curable lacquer 4. In the cases of FIGS. 3, 4, 5 and 6, the primer 17 may be either pre-applied to the wear layer, or be applied downstream from the lamination roller 11 and/or upstream from said step S3 of providing said curable lacquer 4.

The aspects and concepts disclosed in the claims and drawings may be combined with one another as long as they are not mutually contradictory. The present invention is by no means limited to the embodiments described above, however a decorative panel may be realized according to various variants without departing from the scope of the present invention.

1.-60. (canceled)

61. A method for manufacturing a decorative panel, comprising the steps of:
providing a substrate material,
providing at least a decorative layer and a wear layer onto said substrate material, said decorative layer being a prefabricated thermoplastic foil carrying a printed pattern and said wear layer being a prefabricated thermoplastic foil having a thickness (TW) of at least 50 micrometer,
wherein said wear layer is located above said decorative layer,
providing a curable lacquer on said wear layer, and
embossing at least said curable lacquer,
wherein the thickness (TW) of said wear layer and the thickness (TL) of said curable lacquer follow a ratio of between 5:1 and 1:25.

62. The method of claim 61, wherein said curable lacquer is provided onto said wear layer before the step of providing at least said decorative layer and said wear layer onto said substrate material.

63. The method of claim 61, wherein said step of providing at least said decorative layer and said wear layer onto said substrate material, and the step of embossing said curable lacquer on said wear layer is performed at the same time.

64. The method of claim 63, wherein said step of providing at least said decorative layer and said wear layer onto said substrate material, and the step of embossing said curable lacquer on said wear layer is performed by means of a single lamination/embossing roller.

65. The method of claim 61, wherein said curable lacquer is provided onto said wear layer between the step of providing at least said decorative layer and said wear layer onto said substrate material, and the step of embossing said curable lacquer.

66. The method of claim 61, wherein said curable lacquer is provided onto said wear layer during the step of embossing said curable lacquer.

67. The method of claim 66, wherein said curable lacquer has a thickness (TL) on said wear layer of between 10 and 100 μm.

68. The method of claim 66, wherein said curable lacquer has a thickness (TL) on said wear layer of between 300 and 800 μm, preferably between 500 and 800 μm.

69. The method of claim 66, wherein said curable lacquer, before providing it onto said wear layer, is applied onto an embossing roller used during the step of embossing said curable lacquer.

70. The method of claim 61, wherein said curable lacquer has a thickness (TL) on said wear layer of between 10 and 800 μm.

71. The method of claim 61, wherein said curable lacquer is a thermally curable and/or radiation curable, including excimer curable and/or LED curable and/or electron beam curable and/or UV curable, lacquer.

72. The method of claim 71, wherein said curable lacquer is a two-stage curable lacquer, one stage being thermally curable, another stage being excimer and/or LED and/or electron beam and/or UV curable.

73. The method of claim 71, wherein said curable lacquer is precured, i.e. partly cured, onto said wear layer before the step of embossing said curable lacquer.

74. The method of claim 71, wherein said curable lacquer is at least partly cured during said step of embossing.

75. The method of claim 61, wherein said curable lacquer comprises two or more lacquer layers, said lacquer layers having a different gloss degree.

76. The method of claim 61, wherein said wear layer is provided with a thermoplastic primer in between said wear layer and said curable lacquer.

77. The method of claim 61, wherein said curable lacquer is provided onto said wear layer by means of a roller coater.

78. The method of claim 61, wherein said curable lacquer is provided onto said wear layer by means of a transfer film containing said curable lacquer.

79. The method of claim 61, wherein said curable lacquer is finally cured after said step of embossing said curable lacquer by means of excimer and/or LED and/or electron beam and/or UV curing.

80. The method of claim 79, wherein after finally curing said curable lacquer, an additional curable lacquer is applied, and, wherein between said additional curable lacquer and said curable lacquer a primer or adhesion primer is provided.
